(19) United States
(12) Patent Application Publication
(10) Pub. No.: US 2020/0170282 A1
(43) Pub. Date: Jun. 4, 2020

(54) BIRD FEED

(71) Applicant: Petrus Jacobus Van Eeden, Harrismith (ZA)

(72) Inventor: Petrus Jacobus Van Eeden, Harrismith (ZA)

(21) Appl. No.: 16/625,973

(22) PCT Filed: Jun. 27, 2018
(86) PCT No.: PCT/IB2018/054740

§ 371 Date: Dec. 23, 2019

(30) Foreign Application Priority Data
Jun. 27, 2017 (ZA) 2017/04349

(51) Int. Cl. A23K 50/70; A23K 20/158; A23K 10/30; A23K 20/147; A23K 10/20; A23K 20/24; A23K 40/10; A23K 50/75; A23K 20/174; A23K 20/22

(52) U.S. Cl. CPC A23K 50/70; A23K 20/158; A23K 10/30; A23K 20/147; A23K 20/22; A23K 20/24; A23K 40/10; A23K 50/75; A23K 20/174; A23K 10/20

(57) ABSTRACT

A particulate dry bird feed includes, in combination forming greater than 50% by mass of the feed, a protein source and an added vegetable oil-based or animal fat or fatty acid that is admixed together with the protein source, and less than 50% by mass grain or grain-derived ingredients. The invention extends to a method of manufacturing a particulate dry bird feed and to a method of feeding a granivore.

THIS INVENTION relates to bird feed. In particular, the invention relates to a particulate dry bird feed, to a method of manufacturing a particulate dry bird feed and to a method of feeding a granivore.

Many bird species, including doves and pigeons, are granivores. Granivores have a diet that consists primarily, though not always exclusively, of seeds and grain. Also some mammals and invertebrates are seed predators.

Dry animal feed, such as particulate (e.g. pelleted, granulated, prilled or briquetted) dry animal feed for birds and dogs, thus is often starch-based or grain-based. In fact, conventional wisdom is that a feed for birds such as racing pigeons must be almost entirely grain-based, as pigeons are granivores.

The inventor believes that an alternative bird feed high in protein and fat and low in carbohydrate concentrations would be advantageous.

According to one aspect of the invention, there is provided a particulate dry bird feed which includes, in combination forming greater than about 50% by mass of the feed, a protein source and an added vegetable oil-based or animal fat or fatty acid that is admixed together with the protein source, and less than about 50% by mass grain or grain-derived ingredients.

The bid feed may include less than about 25% by mass grain or grain-derived ingredients, or less than about 10% by mass grain or grain-derived ingredients, or less than about 5% by mass grain or grain-derived ingredients, or less than about 1% by mass grain or grain-derived ingredients.

In one embodiment of the invention, the bird feed is substantially free of grain or grain-derived ingredients.

The bird feed may include less than about 10% by mass carbohydrates, or less than about 5% by mass carbohydrates, or less than about 3% by mass carbohydrates, or less than about 2 by mass carbohydrates, e.g. less than about 1% by mass carbohydrates.

The protein source may be selected from the group consisting of egg white, whole egg protein or whole egg powder, soy bean meal, soy protein, pea isolate, larvae meal, fish meal, animal proteins, plant proteins, synthetic amino acids and mixtures of two or more thereof.

Preferably, the protein source is a dry protein source. The protein source may be a spray-dried protein source.

In one embodiment of the invention, the protein source is larvae meal.

Typically, the larvae meal is derived from fly larvae, i.e. dried, defatted fly larvae.

In one embodiment of the invention the protein source is MagMeal™, a dried defatted larvae meal produced by AgriProtein Africa (Pty) Ltd of 1 Rochester Road, Philippi, Cape Town, 7781, South Africa. This larvae meal is believed to be obtained from the larvae of the black soldier fly (Hermetia illucens).

In another embodiment of the invention, the protein source is whole egg powder, e.g. whole egg powder available in South Africa from Sunspray Food Ingredients of 92 Price Street Extension, Industria, 2042, Johannesburg.

The bird feed may be fibre-free.

The added vegetable oil-based or animal fat or fatty acid preferably comprises one or more saturated fatty acids. Even more preferably, the added vegetable oil-based or animal fat or fatty acid comprises predominantly saturated fatty acids.

Preferably, the added vegetable oil-based or animal fat or fatty acid is not liquid at ambient temperature. In one embodiment of the invention, the added vegetable oil-based fat or fatty acid has a melting point which is higher than 45° C., preferably higher than 50° C., more preferably higher than 55° C., most preferably higher than 60° C.

In one embodiment of the invention, the added fat or fatty acid is a vegetable oil-based fat or fatty acid.

The added vegetable oil-based fat or fatty acid may be palm oil-based fat or fatty acid. Thus, the vegetable oil-based fat or fatty acid may comprise fractionated palm fatty acids.

The added vegetable oil-based fat or fatty acid may comprise predominantly palmitic acid (hexadecanoic acid).

The added vegetable oil-based or animal fat or fatty acid may be a spray-dried fat or fatty acid in the form of a powder or granulate.

In one embodiment of the invention, the vegetable oil-based fat or fatty acid is the product BergaFat HPL-106 (trade name) for monogastric animals, produced by Berg & Schmidt GmbH & Co. KG of An der Alster 81, 20099, Hamburg, Germany. This product is a lecithinized or lecithinated palm fat powder without a carrier. It is free of trans fatty acids and has about 6% of a phospholipid complex. Thus, the added vegetable oil-based fat may be a lecithinized palm fat powder without a carrier, which is free of trans fatty acids and which includes a phospholipid complex.

The protein source and the added vegetable oil-based or animal fat or fatty acid may in combination form at least about 70% by mass, or at least about 80% by mass, or at least about 85% by mass, or at least about 90% by mass, or at least about 94% or at least about 98% by mass, of the bird feed.

The added vegetable oil-based or animal fat or fatty acid and the protein source may be present in a mass ratio of added vegetable oil-based or animal fat or fatty acid:protein source of at least 1:2 or at least 1:3, or at least 1:4, or at least 1:5.

The bird feed may include refined sugar. The refined sugar, when present, may be present as an additive in a concentration of between about 0.1% by mass and about 8% by mass, or between about 1% by mass and about 6% by mass, or between about 3% by mass and about 5% by mass, e.g. about 4% by mass.

The bird feed may include CaCO₃. The CaCO₃ may be present as an additive in a concentration of at least 0.1% by mass or at least 1% by mass or at least 2% by mass, e.g. 2.4% by mass. Typically, the CaCO₃ concentration does not exceed about 4% by mass.

The bird feed may include monocalcium phosphate or nonphytate phosphorus.

The monocalcium phosphate or nonphytate phosphorus may be present as an additive in a concentration of between about 0.1% by mass and about 1.1% by mass, or between about 0.15% by mass and about 0.7% by mass, or between about 0.25% by mass and about 0.5% by mass, or between about 0.3% by mass and about 0.4% by mass, e.g. about 0.35% by mass.

The bird feed may include sodium chloride and/or potassium chloride. The sodium chloride and/or potassium chloride may be present as an additive in a concentration of between about 0.01% by mass and about 0.8% by mass, or between about 0.05% by mass and about 0.7% by mass, or between about 0.1% by mass and about 0.6% by mass, e.g. about 0.15% by mass or 0.54% by mass.

The bird feed may include fat soluble and water soluble vitamins and minerals. The vitamins and minerals may be present as an additive in a concentration of between about 0.01% by mass and about 2.5% by mass, or between about 0.05% by mass and about 2.0% by mass, or between about 0.1% by mass and about 1.75% by mass, e.g. about 0.13% by mass.

In one embodiment of the invention, the water soluble vitamins and minerals are present as an additive in the form of Phenix® Stresspac PO available in South Africa from Virbac RSA (Pty) Limited of 38 Landmarks Avenue, 0157, Centurion. Phenix® Stresspac PO is a water soluble vitamin and electrolyte supplement for poultry and ostriches. The product was developed as a nutritional aid in the prevention and management of stress and dehydration resulting in the loss of vitamins and electrolytes. Twelve quality vitamins as well as electrolytes are included in the product.

The bird feed may include a methionine source. The methionine source, when present, may be present as an additive in a concentration of between about 0.1% by mass and about 2.5% by mass, or between about 0.25% by mass and about 1.5% by mass, or between about 0.4% by mass and about 0.6% by mass, e.g. about 0.5% by mass.

In one embodiment of the invention, the methionine source is MHA®, a feed supplement produced by Novus International, Inc. of 20 Research Park Drive, Saint Charles, Mo., 63304, USA.

The bird feed may include lysine. The lysine, when present, may be present as an additive in a concentration of between about 0.1% by mass and about 2.5% by mass, or between about 0.5% by mass and about 2.0% by mass, or between about 1.0% by mass and about 1.5% by mass, e.g. about 1.3% by mass.

The bird feed may have a crude protein concentration of at least about 10% by mass, or at least about 25% by mass, or at least about 30% by mass, or at least about 35% by mass, e.g. about 35% by mass.

The bird feed may have an energy content (i.e. metabolizable energy) of at least 12.8 MJ/kg or at least 20 MJ/kg or at least 25 MJ/kg.

In one embodiment of the invention the bird feed includes one or more additives selected from the group consisting of refined sugar, monocalcium phosphate, nonphytate phosphorus, sodium chloride, potassium chloride, fat soluble vitamins and minerals, water soluble vitamins and minerals, a methionine source, lysine, electrolytes, taurine, creatine monohydrate, niacin and thiamine.

Creatine is involved in muscular energetic systems and is an important addition to the diet of any athletic population. Taurine is also important for muscular activity and nervous system function. Niacin, creatine monohydrate and taurine are available in South Africa from Lake Foods, a division of AECI Ltd, Unit 2 Galaxy Office Park, 17 Galaxy Avenue, Linbro Business Park, Sandton, 2065.

The bird feed may be in the form of extruded or granulated or prilled bodies, in particular in the form of extruded pellets.

The pellets may be cylindrical, preferably circular cylindrical.

The pellets may have a maximum transverse dimension or a diameter of between about 1.5 mm and about 8 mm, or between about 2 mm and about 5 mm, or between about 3 mm and about 4 mm, e.g. about 2.5 mm or about 3.5 mm.

The pellets may have a length dimension of between about 2 mm and about 20 mm, or between about 4 mm and about 15 mm, or between about 5 mm and about 8 mm, e.g. about 6 mm.

The bird feed may be a granivore feed.

The bird feed may be a racing pigeon feed.

According to another aspect of the invention, there is provided a method of manufacturing a particulate dry bird feed, the method including

admixing a protein source and a vegetable oil-based or animal fat or fatty acid, to form an admixture in which the protein source and the vegetable oil-based fat or fatty acid, in combination form at least about 50% by mass of the admixture; and

shaping the admixture into particulate dry bird feed bodies with a maximum dimension of about 20 mm.

Typically, the protein source is a dry protein source.

Typically, the vegetable oil-based or animal fat or fatty acid is not liquid at ambient temperature.

Shaping the admixture into particulate dry bird feed bodies may include extruding or granulating or prilling or pelletizing the admixture to form dry bird feed bodies. Preferably, the admixture is extruded to form extruded pellets.

The pellets may be as hereinbefore described.

If the admixture includes any grain, the admixture has less than 50% by mass grain.

The grain content of the admixture may be as hereinbefore described.

The protein source may be as hereinbefore described.

The vegetable oil-based or animal fat or fatty acid may be as hereinbefore described.

The protein source and the vegetable oil-based or animal fat or fatty acid may be admixed to form an admixture in which the protein source and the vegetable oil-based or animal fat or fatty acid in combination make up a mass percentage of the admixture as hereinbefore described.

The protein source and the vegetable oil-based or animal fat or fatty acid may be admixed in a mass ratio of added vegetable oil-based or animal fat or fatty acid:protein source as hereinbefore described.

The method may include adding refined sugar to the admixture. The added refined sugar may be present in the admixture in a concentration (% by mass) as hereinbefore described.

The method may include adding CaCO₃ to the admixture. The added CaCO₃ may be present in the admixture in a concentration (% by mass) as hereinbefore described.

The method may include adding monocalcium phosphate or nonphytate phosphorous to the admixture. The added monocalcium phosphate or nonphytate phosphorous may be present in the admixture in a concentration (% by mass) as hereinbefore described.

The method may include adding sodium chloride and/or potassium chloride to the admixture. The added sodium chloride may be present in the admixture in a concentration (% by mass) as hereinbefore described.

The method may include adding vitamins and minerals to the admixture. The added vitamins and minerals may be present in the admixture in a concentration (% by mass) as herein before described.

The method may include adding a methionine source to the admixture. The added methionine source may be present in the admixture in a concentration (% by mass) as herein before described.

The method may include adding lysine to the admixture. The added lysine may be present in the admixture in a concentration (% by mass) as hereinbefore described.

The method may include adding to the admixture one or more additives selected from the group consisting of refined sugar, monocalcium phosphate, nonphytate phosphorus, sodium chloride, potassium chloride, fat soluble vitamins and minerals, water soluble vitamins and minerals, a methionine source, lysine, electrolytes, taurine, creatine monohydrate, niacin and thiamine.

According to another aspect of the invention, there is provided a method of feeding a granivore, the method including providing to the granivore a dry particulate animal feed which includes, in combination forming greater than about 50% by mass of the feed, a protein source and an added vegetable oil-based fat or fatty acid, and less than about 50% by mass grain or grain-derived ingredients.

The dry particulate animal feed may be a bird feed as hereinbefore described.

The granivore may be a bird.

The bird may be a racing pigeon or poultry.

The invention will now be described in more detail with reference to the following examples:

### EXAMPLE 1

A bird feed, suitable for feeding to racing pigeons, was prepared in accordance with the following formulation:

| Ingredient | Mass % |
|---|---|
| Virbac Phenix ® Stresspac PO, gelatin powder, | 0.1% |
| extreme electrolyte, dried cheese | |
| Taurine | 0.05% |
| Creatine monohydrate | 0.05% |
| Larvae meal (MagMeal ™) | 67% |
| A vegetable oil-based fat or fatty acid | 32.8% |
| (BergaFat HPL-106 for monogastric animals) | |

This formulation was mechanically admixed and pelleted through a pellet machine to provide pellets that were circular cylindrical in cross-section with a diameter of about 3 mm and a length of about 6 mm.

In place of the larvae meal, or in partial substitution thereof, spray dried egg can be used.

The dry pelleted bird feed had a crude protein content of 33% by mass, a fat content of 40% by mass, a fibre content of 8.7% by mass and an energy content of 21.84 MJ/kg (on a dry matter basis).

Virbac Phenix® Stresspac PO has a composition as set out in the following table:

Composition per kg

| | | |
|---|---|---|
| Vitamin A | 15 000 000 | IU |
| Vitamin E | 25 000 | mg |
| Vitamin B2 (riboflavin) | 5 000 | mg |
| Vitamin B6 (pyridoxine) | 2 000 | mg |
| Folic acid | 500 | mg |
| Pantothenic acid | 10 000 | mg |
| Sodium chloride | 150 000 | mg |
| Vitamin D3 | 1 500 000 | IU |
| Vitamin K | 4 000 | mg |
| Niacin | 2 500 | mg |
| Vitamin B12 | 20 | mg |
| Biotin | 40 | mg |
| Vitamin C | 150 000 | mg |
| Potassium chloride | 10 000 | mg |

Virbac Phenix® Stresspac PO is usually applied, for poultry and ostriches, as a 1×100 g sachet per 100 kg complete feed.

The dry bird feed prepared in accordance with Example 1 was fed to racing pigeons. Anecdotal evidence suggests that the racing pigeons are showing an increase in performance of up to about 15%, compared to when they were fed on conventional grain-based feed. Thus, a pigeon travelling 20 miles in 20 minutes with no wind can travel 20 miles in 17 minutes with no wind. This is a result of the pigeon weighing about 15% less due to the feed.

### EXAMPLE 2

A bird feed suitable for racing pigeons was formulated as follows:

| Ingredient | Mass % |
|---|---|
| Virbac Phenix ® Stresspac PO, gelatin powder, | 0.13% |
| extreme electrolyte, dried cheese | |
| Vitamin and mineral premix | 0.55% |
| Taurine | 0.06% |
| Niacin | 0.01% |
| Thiamine | 0.002% |
| Whole egg powder | 82.498% |
| Calcium carbonate | 2.4% |
| A vegetable oil-based fat or fatty acid | 14.35% |
| (BergaFat HPL-106 for monogastric animals) | |

This formulation was admixed and pelleted as described in Example 1. The dry pelleted bird feed had a crude protein content of 37%, a fat content of 51%, zero % fibre and an energy content of 25.7 MJ/kg.

### EXAMPLE 3

A bird feed in accordance with the invention was prepared from BergaFat HPL-106 and larvae meal (MagMeal™). The bird feed had a 33% by mass protein content, a 40% by mass fat content, 8.7% by mass fibre content and an energy content of 20.5 MJ/kg. This bird feed however leads to higher moisture take-up by birds, as a result of the presence of the larvae meal fibres, and hence to an increase in bird. This bird feed was given to racing pigeons as a 33 g/day ration.

### EXAMPLE 4

A bird feed in accordance with the invention was prepared from BergaFat HPL-106 and whole egg protein, instead of larvae meal, to eliminate chitin fibre, to improve on caloric density and to boost calcium and vitamin D content. The bird feed had a 32% by mass protein content, a 61% by mass fat content, 0.74% by mass carbohydrates, 0% fibre, a low moisture content and an energy content of 28.6 MJ/kg.

Whole egg powder advantageously includes helpful amounts of essential amino acids such as threonine, cysteine and methionine and does not include chitin fibre, unlike larvae meal. The chitin fibre undesirably reduces protein digestibility and absorbs water.

### EXAMPLE 5

A bird feed in accordance with the invention was prepared from BergaFat HPL-106 and whole egg protein to lower the caloric density to address a potential issue with birds (racing pigeons) not eating enough of the calorie-dense food of Example 4 to meet their desired 11 g/day protein intake. The protein content was increased so that the birds can ingest 11 g protein daily in approximately 29 g feed/day. The fat content was lowered to reduce the caloric density. The bird feed had a 37% by mass protein content, a 51% by mass fat content, 11% by mass ash (from calcium carbonate), 0% fibre, 1% carbohydrates and an energy content of 25.5 MJ/kg.

The bird feed of Examples 4 and 5 improve on the mineral content, particularly calcium and phosphorus, vitamin D content and energy content of the bird feed of Example 3, and address a potential soft egg shall problem identified with the bird feed of Example 3.

### EXAMPLE 6

A bird feed, suitable for feeding to racing pigeons, was prepared in accordance with the following formulation:

| | Mass per | Mass | Mass | |
|---|---|---|---|---|
| | daily ration | per | per | |
| | of 27.9 g | kg | 100 kg | |
| | feed | ration | ration | Mass |
| Ingredient | (g) | (g) | (kg) | % |
| Whole egg powder | 23 | 824.59 | 82.46 | 82.5 |
| A vegetable oil-based fat | 4 | 143.41 | 14.34 | 14.35 |
| or fatty acid (BergaFat | | | | |
| HPL-106 for monogastric | | | | |
| animals) | | | | |
| Calcium carbonate | 0.67 | 24.02 | 2.40 | 2.4 |
| Potassium chloride | 0.15 | 5.38 | 0.54 | 0.54 |
| Virbac Phenix ® | 0.035 | 1.25 | 0.13 | 0.13 |
| Stresspac PO | | | | |
| Taurine powder | 0.0175 | 0.63 | 0.0627 | 0.06 |
| Creatine monohydrate | 0.0175 | 0.63 | 0.0627 | 0.01 |
| powder | | | | |
| Niacin | 0.002 | 0.07 | 0.0072 | 0.01 |
| Thiamine (Vitamin B1) | 0.0005 | 0.02 | 0.0018 | 0.002 |
| Total | 27.9 | 1000 | 100 | 100 |

The bird feed of Example 6 provides an energy content as set out below:

| | | Mass per | | | Glycaemic | Dietary | |
|---|---|---|---|---|---|---|---|
| | Ingredient | daily ration | Protein | Fats per | carbohydrates | fibre per | Calories |
| | mass/100 g | of 27.9 g | per 100 g | 100 g | per 100 g feed | 100 g | per 100 g |
| Ingredient | feed (g) | feed (g) | feed (g) | feed (g) | (g) | feed (g) | feed (kcal) |
| Whole egg powder | 79.6 | 23 | 39.6 | 36.2 | 0.93 | 0 | 487.9 |
| A vegetable oil-based | 13.2 | 4 | 0 | 14.2 | 0 | 0 | 127.8 |
| fat or fatty acid | | | | | | | |
| (BergaFat HPL-106 for | | | | | | | |
| monogastric animals) | | | | | | | |
| Additives | 7.2 | 0.9 | 0 | 0 | 0 | 0 | 0 |
| Total | | | 39.6 | 50.4 | 0.93 | 0 | 616 |

Thus, 1 kg of feed has an energy content of 10×616×4.187 kJ=25.7 MJ. The whole egg powder and the fats are the only two sources of calories in the ration, with all of the other additives being non-caloric.

This bird feed consists of 39.6% by mass protein and 50.4% by mass fats as macronutrients. Glycaemic carbohydrates are extremely low at 0.93% by mass and the feed is free from dietary fibre. Ash and moisture makes up about 9.1% by mass of the feed.

Assuming a 28 g daily ration, a bird will receive 11.4 g protein, 14.1 g fats, 0.26 g carbohydrates, 0 g fibres and 720 kJ of energy.

The bird feed of Example 6 provides the minerals as set out in the following table, meeting the daily requirement for racing pigeons for calcium, chlorine, magnesium, phosphorus, potassium and sodium:

Amounts supplied by some of the feed ingredients per 28 g ration

| | | 23 g | | | |
|---|---|---|---|---|---|
| | Calculated | whole | 0.15 g | 0.67 g | |
| Macro | requirement | egg | potassium | calcium | |
| minerals | mg/day | powder | chloride | carbonate | Total |
| Calcium | 360 | 56.1 | | 270 | 326.1 |
| Chlorine | 63 | | 70 | | 70 |
| Magnesium | 13.5 | 7.8 | | 7.2 | 15.0 |
| Phosphorus | 135 | 144.6 | | 2.52 | 147.2 |
| Potassium | 180 | 124.2 | 75 | 2.4 | 201.6 |
| Sodium | 67.5 | 109.5 | | | 109.5 |
| Iron | | 1.7 | | | 1.7 |
| Zinc | | 0.72 | | | 0.72 |
| Copper | | 0.046 | | | 0.046 |
| Manganese | | 0.013 | | | 0.013 |
| Selenium | | 38.5 | | | 38.5 |

The bird feed of Example 6 provides the vitamins as set out in the following table, meeting the daily requirement for racing pigeons for vitamins A, D3, E and K, B12, biotin, choline, folacin, pantothenic acid, pyridoxine and riboflavin, with added niacin and added thiamine:

| | | | 35 mg Virbac | |
|---|---|---|---|---|
| | | | Phenix ® | |
| | | 23 g | Stresspac PO | |
| | | whole egg | per 28 g ration | |
| | | powder | at recommended | |
| | Unit/day | per 28 g | level of use | |
| | required | ration | (1.2 g/kg) | Total |
| Fat soluble | | | | |
| vitamins | | | | |
| Vitamin A (IU) | 74.25 | 229.8 | 495 | 724.8 |
| Vitamin D3 (ICU) | 33.75 | 76.1 | 99 | 175.1 |
| Vitamin E (IU) | 0.54 | 0.89 | 1.65 | 2.5 |
| Vitamin K (mg) | 0.045 | 0.00027 | 0.13 | 0.13 |
| Water soluble | | | | |
| vitamins | | | | |
| Vitamin B12 | 0.135 | 0.68 | 0.7 | 1.38 |
| (mcg/day) | | | | |
| Biotin (mcg/day) | 13.5 | 16 | 1.4 | 17.4 |
| Choline | 90 | 231.6 | | 231.6 |
| Folacin | 45 | 27.4 | 17.5 | 44.9 |
| (mcg/day) | | | | |
| Niacin (mg/day) | 1.8 | 0.078 | 0.088 | 0.17 |
| Pantothenic acid | 0.45 | 1.28 | 0.35 | 1.6 |
| (mg/day) | | | | |
| Pyridoxine | 0.135 | 0.12 | 0.07 | 0.19 |
| (mg/day) | | | | |
| Riboflavin | 0.18 | 0.44 | 0.18 | 0.61 |
| (mg/day) | | | | |
| Thiamine | 0.09 | 0.042 | | 0.042 |
| (mg/day) | | | | |

Although the vitamin A level is high, it is well within the level of use for poultry and racing pigeons. Vitamin A also undergoes a degree of oxidation and degradation during pelleting, storing and exposure to oxygen and light so that an excess of vitamin A will make up for such losses.

With added niacin and added thiamine, the bird feed of Example 6 brings daily intake to 2.1 mg niacin/35 g ration and to an adequate level for thiamine.

It is believed that the bird feed of Example 6 meets, from the use of whole egg powder, the daily requirements for pigeons of protein, arginine, glycine+serine, histidine, isoleucine, leucine, methionine, cystine, methionine+cystine, phenylalanine, phenylalanine+tyrosine, threonine, tryptophan and valine. The requirements for alanine, aspartic acid, glutamic acid and proline are not met.

Whole egg powder is also a valuable source of fat-soluble vitamins (A, D, E and K), a decent source of water-soluble vitamins, including biotin, choline and vitamin K and has a fat content of about 44% by mass. Egg white powder, if available, is even higher in protein (84% by mass) than whole egg powder and less powder can then be used, which may reduce the cost of the bird feed.

For a comparison between the nutritional value of whole egg powder, egg yolk powder and egg white powder, one can refer to the following two tables, based on information provided by the US Department of Agriculture, Agriculture Research Service, Nutrient Data Laboratory:

| | | | Dried |
|---|---|---|---|
| | Dried | Dried | stabilized |
| | whole egg | egg yolk | egg white |
| Nutrients per 100 g | powder | powder | powder |
| Protein (g) | 48.05 | 33.63 | 84.08 |
| Moisture (g) | 2.78 | 3.08 | 5.48 |
| Fat (g total lipid) | 43.9 | 59.13 | 0.32 |
| Ash (g) | 4.13 | 3.51 | 5.61 |
| Carbohydrate (g) | 1.13 | 0.66 | 4.51 |
| Glucose (g) | 0.56 | 0.23 | 0 |
| Calories (kcal) | 592 | 669 | 376 |
| Cholesterol (mg) | 1630 | 2307 | 0 |

| | | | Dried |
|---|---|---|---|
| Amino acids per | Dried | Dried | stabilized |
| 100 g | whole egg | egg yolk | egg white |
| (g) | powder | powder | powder |
| Alanine | 2.706 | 1.751 | 5.313 |
| Arginine | 3.071 | 2.336 | 4.812 |
| Aspartic acid | 5.02 | 3.31 | 7.291 |
| Cystine | 1.07 | 0.588 | 2.044 |
| Glutamic acid | 6.388 | 4.263 | 11.496 |
| Glycine | 1.623 | 1.043 | 3.085 |
| Histidine | 1.202 | 0.861 | 1.872 |
| Isoleucine | 2.434 | 1.701 | 5.023 |
| Leucine | 4.15 | 2.908 | 7.172 |
| Lysine | 3.339 | 2.469 | 5.076 |
| Methionine | 1.495 | 0.858 | 3.204 |
| Phenylalanine | 2.53 | 1.472 | 5.181 |
| Proline | 1.832 | 1.326 | 3.098 |
| Serine | 3.773 | 2.814 | 6.078 |
| Threonine | 2.129 | 1.545 | 3.665 |
| Tryptophan | 0.775 | 0.39 | 1.266 |
| Tyrosine | 1.981 | 1.422 | 3.309 |
| Valine | 2.991 | 1.934 | 6.17 |

The bird feed of Example 6, in summary, typically provides the nutrition as set out in the following table:

| | Per 27.9 g | Per | Per |
|---|---|---|---|
| | ration | 100 g | kilogram |
| Energy (MJ) | 0.717 MJ | 2.57 MJ | 25.7 MJ |
| Protein (g) | 11.04 | 39.6 | 395.7 |
| Carbohydrates (g) | 0.26 | 0.9 | 9.32 |
| Fats (g) | 15.05 | 53.9 | 639.43 |
| Fibre (g) | 0 | 0.0 | 0.00 |
| Arginine (g) | 0.69 | 2.47 | 24.73 |
| Glycine + Serine (g) | 1.24 | 4.45 | 44.48 |
| Histidine (g) | 0.28 | 0.99 | 9.89 |
| Isoleucine (g) | 0.56 | 2.01 | 20.07 |
| Leucine (g) | 0.95 | 3.42 | 34.21 |
| Lysine (g) | 0.77 | 2.75 | 27.53 |
| Methionine (g) | 0.34 | 1.23 | 12.32 |
| Cystine (g) | 0.25 | 0.88 | 8.82 |
| Methionine + cystine (g) | 0.59 | 2.11 | 21.15 |
| Phenylalanine (g) | 0.58 | 2.09 | 20.86 |
| Phenylalanine + Tyrosine (g) | 1.04 | 3.72 | 37.19 |
| Threonine (g) | 0.54 | 1.92 | 19.20 |
| Tryptophan (g) | 0.18 | 0.64 | 6.39 |
| Valine (g) | 0.69 | 2.47 | 24.66 |
| Alanine (g) | 0.62 | 2.22 | 22.22 |
| Aspartic acid (g) | 1.15 | 4.12 | 41.22 |
| Glutamic acid (g) | 1.47 | 5.27 | 52.69 |
| Proline (g) | 0.42 | 1.51 | 15.05 |
| Calcium (mg) | 326.12 | 1168.89 | 11688.9 |
| Chlorine (mg) | 70.00 | 250.90 | 2509.0 |
| Magnesium (mg) | 28.52 | 102.22 | 1022.2 |
| Phosphorous (mg) | 147.19 | 527.56 | 5275.6 |
| Potassium (mg) | 201.60 | 722.58 | 7225.8 |
| Sodium (mg) | 109.48 | 392.40 | 3924.0 |
| Iron (mg) | 1.66 | 5.94 | 59.4 |
| Zinc (mg) | 0.72 | 2.60 | 26.0 |
| Copper (mg) | 0.05 | 0.16 | 1.6 |
| Manganese (mg) | 0.01 | 0.05 | 0.5 |
| Selenium (μg) | 38.50 | 138.00 | 1380.0 |
| Vitamin A (IU) | 724.77 | 2597.74 | 25977.42 |
| Vitamin D3 (ICU) | 175.13 | 627.71 | 6277.06 |
| Vitamin E (IU) | 2.54 | 9.11 | 91.13 |
| Vitamin K (mg) | 0.13 | 0.47 | 4.67 |
| Vitamin B12 (μg) | 1.38 | 4.95 | 49.49 |
| Biotin(μg) | 17.40 | 62.37 | 623.66 |
| Choline (mg) | 231.62 | 830.19 | 8301.92 |
| Folacin (μg) | 44.87 | 160.82 | 1608.24 |
| Niacin (mg) | 0.17 | 0.59 | 5.94 |
| Pantholenic acid (mg) | 1.63 | 5.83 | 58.30 |
| Pyridoxine (mg) | 0.19 | 0.66 | 6.63 |
| Riboflavin (mg) | 0.61 | 2.19 | 21.94 |
| Thiamine (mg) | 0.09 | 0.32 | 3.23 |
| Vitamin C (mg) | 5.25 | 18.42 | 184.21 |

The formulations, as exemplified, are nutritionally balanced even though they do not include grain or grain-derived ingredients in significant proportions, or are even grain free, and can easily be shaped, e.g. pelleted, to form particulate dry bird feed. Advantageously, in some embodiments, the bird feed is fibre-free and has a very low carbohydrate content. Compared to commercially available bird feeds of which the inventor is aware, that are suitable for feeding to birds such as racing pigeons, the bird feed of the invention is higher in protein content and higher in fat content. The bird feed of the invention in at least some embodiments is lower in fibre content (even fibre-free), much lower in carbohydrate content and higher in energy density than such commercially available bird feeds. As a result of the high energy content of the feed, a bird with a relatively small crop, such as a racing pigeon, can consume sufficient of the particulate dry bird feed to perform optimally, particularly when compared to the situation where the pigeon is fed maize, which quickly fills the pigeon's crop but which has a much lower energy content and which makes the pigeon heavier.

What is claimed is:

1. A particulate dry bird feed which includes,
in combination forming greater than 50% by mass of the feed, a protein source and an added vegetable oil-based fat or fatty acid or an added animal fat or fatty acid that is admixed together with the protein source; and
less than 50% by mass grain or grain-derived ingredients.

2. The bird feed according to claim 1, which includes less than 25% by mass or less than 10% by mass or less than 5% by mass or less than 1% by mass grain or grain-derived ingredients.

3. The bird feed according to claim 1, wherein the protein source is selected from the group consisting of egg white, whole egg protein or whole egg powder, soy bean meal, soy protein, pea isolate, larvae meal, fish meal, animal proteins, plant proteins, synthetic amino acids and mixtures of two or more thereof.

4. The bird feed according to claim 1, wherein the added vegetable oil-based fat or fatty acid or the added animal fat or fatty acid comprises predominantly saturated fatty acids, and/or wherein the added vegetable oil-based fat or fatty acid or the added animal fat or fatty acid is not liquid at ambient temperature, and/or wherein the added vegetable oil-based fat or fatty acid or the added animal fat or fatty acid is a spray-dried fat or fatty acid in the form of a powder or granulate.

5. The bird feed according to claim 1, wherein the added fat or fatty acid is a vegetable oil-based fat or fatty acid, and/or wherein the added vegetable oil-based fat or fatty acid is palm oil-based fat or fatty acid.

6. The bird feed according to claim 5, wherein the added vegetable oil-based fat or fatty acid is predominantly palmitic acid.

7. The bird feed according to claim 1, in which the added vegetable oil-based fat is a lecithinized palm fat powder without a carrier, which is free of trans fatty acids and which includes a phospholipid complex.

8. The bird feed according to claim 1, wherein the protein source and the added vegetable oil-based fat or fatty acid or the added animal fat or fatty acid form at least 70% by mass, or at least 80% by mass, or at least 85% or at least 90% by mass of the bird feed.

9. The bird feed according to claim 1, wherein the added vegetable oil-based fat or fatty acid or the added animal fat or fatty acid and the protein source are present in a mass ratio of added vegetable oil-based fat or fatty acid or added animal fat or fatty acid:protein source of at least 1:2 or at least 1:3, or at least 1:4, or at least 1:5.

10. The bird feed according to claim 1, which includes added CaCO₃ which is present as an additive in a concentration of at least 0.1% by mass or at least 1% by mass or at least 2% by mass.

11. The bird feed according to claim 1, which has an energy content of at least 12.8 MJ/kg or at least 20 MJ/kg or at least 25 MJ/kg.

12. The bird feed according to claim 1, which includes one or more additives selected from the group consisting of refined sugar, monocalcium phosphate, nonphytate phosphorus, sodium chloride, potassium chloride, fat soluble vitamins and minerals, water soluble vitamins and minerals, a methionine source, lysine, electrolytes, taurine, creatine monohydrate, niacin and thiamine.

13. A method of manufacturing a particulate dry bird feed, the method including
admixing a protein source and a vegetable oil-based fat or fatty acid or an animal fat or fatty acid, to form an admixture in which the protein source and the fat or fatty acid, in combination form at least 50% by mass of the admixture; and
shaping the admixture into particulate dry bird feed bodies with a maximum dimension of 20 mm.

14. The method according to claim 13, wherein the protein source is a dry protein source and wherein the vegetable oil-based fat or fatty acid or the animal fat or fatty acid is not liquid at ambient temperature, and/or wherein the admixture includes less than 25% by mass or less than 10% by mass or less than 5% by mass or less than 1% by mass grain or grain-derived ingredients.

15. The method according to claim 13, wherein the protein source and the vegetable oil-based fat or fatty acid or the animal fat or fatty acid are admixed to form an admixture in which the protein source and the vegetable oil-based fat or fatty acid or the animal fat or fatty acid in combination make up at least 70% by mass, or at least 80% by mass, or at least 85% by mass or at least 90% by mass of the admixture.

16. A method of feeding a granivore, the method including providing to the granivore a dry particulate animal feed according to claim 1.

17. (canceled)

18. The method according to claim 16, in which the granivore is a bird or in which the granivore is a racing pigeon or in which the granivore is poultry.
